(19) United States
(12) Patent Application Publication
(10) Pub. No.: US 2026/0054241 A1
(43) Pub. Date: Feb. 26, 2026

(54) HIGH PRESSURE HYDROGEN REACTOR

(71) Applicant: Massachusetts Institute of Technology, Cambridge, MA (US)

(72) Inventors: Mark Donahue, Littleton, MA (US); Eric Morgan, Harvard, MA (US)

(73) Assignee: Massachusetts Institute of Technology, Cambridge, MA (US)

(21) Appl. No.: 19/009,894

(22) Filed: Jan. 3, 2025

Related U.S. Application Data
(60) Provisional application No. 63/618,267, filed on Jan. 5, 2024.

(51) Int. Cl. B01J 8/08; B01J 8/00; C01B 3/08

(52) U.S. Cl. CPC B01J 8/087; B01J 8/003; C01B 3/08; B01J 2208/00141; B01J 2208/00752

(57) ABSTRACT

In some embodiments, a reactor and/or related methods may produce pressurized hydrogen gas by combining a reactant and water within a reactor chamber. The hydrogen gas may be siphoned from the reactor and used in associated systems.

### RELATED APPLICATIONS

This application claims priority under 35 U.S.C. § 119(e) to U.S. Provisional Application No. 63/618,267 filed Jan. 5, 2024, which is incorporated herein by reference in its entirety for all purposes.

### GOVERNMENT LICENSE RIGHTS

This invention was made with government support under FA8702-15-D-0001 awarded by the U.S. Air Force. The government has certain rights in the invention.

### TECHNICAL FIELD

Disclosed embodiments are related to high pressure hydrogen reactors and related methods of use.

### BACKGROUND

Hydrogen gas has been well recognized as an emission-free fuel holding promise for a more sustainable energy economy compared to fossil fuels. Oxidation-reduction reactions involving metals can produce hydrogen on-demand eliminating the cost, storage, and transport issues associated with storing hydrogen as a gas or liquid at high-pressure. Aluminum (Al), for example, has an energy density about two times greater than diesel fuel and forty times greater than lithium ion, and reacts with water to produce hydrogen.

### SUMMARY

In some embodiments, a reactor for producing hydrogen gas includes a reactor chamber configured to contain a reactant and water, wherein when the reactant is combined with the water in the reactor chamber a reaction produces hydrogen gas. The reactor further includes a cooling liquid source and a heat exchanger disposed in the reactor chamber, wherein the heat exchanger and the cooling liquid source are configured to flow a cooling liquid from the cooling liquid source through the heat exchanger.

In some embodiments, a method of producing hydrogen gas includes combining a reactant and water in a reactor chamber to produce hydrogen, and flowing a cooling liquid between a heat exchanger disposed within the reactor chamber and a cooling liquid source to maintain a temperature of the reactor chamber below a threshold temperature.

Other advantages and novel features of the present disclosure will become apparent from the following detailed description of various non-limiting embodiments of the disclosure when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIG. 1 is a schematic of a high-pressure reactor according to one embodiment; and

FIG. 2 is a method flow diagram of a method for producing hydrogen using a high-pressure reactor according to some embodiments.

### DETAILED DESCRIPTION

For many use cases, high-pressure hydrogen used as a fuel source may provide increased operation time and/or increased operational range. For example, it may be desirable to utilize hydrogen in unmanned vehicles (aerial and ground), watercraft, space vehicles, and other applications to improve performance. However, current methods make it infeasible to produce high-pressure hydrogen in remote applications. Conventionally, pressurized hydrogen may be produced by large fixed reactors and stored at high pressures (e.g. between 10 MPa and 40 MPa) for transportation to a point of use. Low-pressure hydrogen reactors may use pumps and/or other components to increase a pressure of the produced hydrogen. Such equipment may be bulky, energy intensive, and difficult to implement, especially in remote locations with limited access to resources (water, electricity, etc.). For example, methods for increasing the pressure of hydrogen for high pressure usage may use approximately 10% to 50% of the usable energy.

In view of the above, the Inventors have recognized the need for the ability to generate hydrogen at medium to high pressure to power equipment, fill reusable tanks, and/or for any other appropriate use where high pressure hydrogen may be desirable. More specifically, the Inventors have recognized that combining water-reactive materials and water in a fixed, rigid volume can produce self-pressurized hydrogen gas. This may reduce or eliminate the need to pressurize the hydrogen using ancillary equipment. The contemplated reactor can produce hydrogen at high pressure which can be stored for later use and/or can provide continuous production of hydrogen for supply directly to a desired end use.

In addition to the above, the Inventors have appreciated that producing hydrogen with highly water-reactive materials can generate steam immediately around the reaction site. The heat represented by this steam can be on the order of tens of kilowatts. If this steam and heat generation are not controlled during hydrogen generation, the increased pressures and temperatures can lead to various issues. For example, the steam can degrade downstream equipment. Additionally, boiling may disrupt the reaction between the water and the water reactive material due to the disruption of the liquid-solid interface with gaseous water, and loss of reaction water can hinder the continuous operation of the reaction. Excess heat produced within the reactor may also degrade the solid fuel and/or damage temperature sensitive components of the reactor such as seals, valves, and/or other components of the reactor.

In view of the above, the Inventors have recognized that it may be desirable to cool a high-pressure hydrogen reactor during the exothermic reaction of a water reactive material and water within the reactor. For example, one method of producing hydrogen gas at high pressures includes combining a reactant comprising a water-reactive material (e.g. an activated aluminum) with a reactive liquid (e.g. water) in a fixed volume. The fixed volume may be rigid to promote pressurization during operation. The Inventors have appreciated that a limited head space within the fixed volume causes hydrogen gas to self-pressurize, allowing a reactor to produce hydrogen gas at medium to high pressures. In some embodiments, the cooling may include maintaining a temperature of the reactor below a boiling point of the reactive liquid and/or a threshold temperature less than a boiling point of the reactive liquid at a desired operational pressure of the reactor during nominal operation. It is appreciated that reducing a temperature within an internal volume of the reactor may also reduce an amount of steam contained within a flow of hydrogen.

According to some embodiments, a reactor used to implement the above method includes a reactor chamber configured to contain the water-reactive material and water. The reactor chamber may comprise a fixed volume within which water and the water-reactive material are combined to produce hydrogen under pressure. Without wishing to be bound by theory, a reaction between water and a water-reactive material under pressure may result in relatively high temperatures. Thus, the reactor chamber may comprise any appropriate rigid material configured to withstand the expected operational pressures and temperatures within the reactor chamber during nominal operation of the reactor and/or configured to resist hydrogen embrittlement. Depending on the embodiment the reactor chamber may comprise a composite material, a polymer-coated metal, a non-reactive metal, a high temperature plastic, or any other appropriate non-reactive material capable of operating at the desired temperatures and pressures with the disclosed water reactive materials as the disclosure is not so limited.

In some embodiments, a reactor used to implement the above method may comprise a heat exchanger disposed within an internal volume of the reactor chamber to regulate a temperature within the reactor chamber. The heat exchanger may be rigid and configured to withstand pressures within the reactor chamber as a pressure within the heat exchanger may be less than a pressure within the reactor chamber. The heat exchanger may be any appropriate heat exchanger as the disclosure is not so limited. A cooling liquid may flow from a cooling liquid source to the heat exchanger to remove heat from the reactor chamber. In some embodiments, the cooling liquid may be circulated between the heat exchanger and the cooling liquid source to transfer the heat to an external environment. However, embodiments in which the cooling liquid is not recirculated are also contemplated. In either case, the heat exchanger and flow of cooling liquid may be properly selected and controlled to maintain a desired operating temperature within the reactor during operation. For example, the temperature within the reactor chamber may be regulated to prevent the water in the internal volume from boiling depending on the pressure within the internal volume. It is contemplated that the operation of the heat exchanger may be controlled in any desired manner (e.g. active control, sensors, controllers, flow rate control, passive set point control, etc.) as the disclosure is not so limited.

It is contemplated that the heat exchanger may comprise any non-reactive material that does not substantially react with the water and/or water reactive material. For example, the heat exchanger may comprise stainless steel, copper, a non-reactive metallic alloy, a polymer coated metal, and/or any other appropriate material as the disclosure is not so limited. It is contemplated that hydrogen embrittlement may be a potential issue depending on the selected metal or alloy. As such, it may be advantageous to mitigate potential embrittlement issues by providing a hydrogen impermeable coating on the selected metal or alloy in some embodiments such that the heat exchanger may be configured to resist hydrogen embrittlement.

Depending on the embodiment, any appropriate type of cooling fluid may flow through a heat exchanger disposed within the internal volume of a reactor to regulate the temperature within the internal volume. Appropriate cooling fluids may include, but are not limited to water, a refrigerant, and/or any other appropriate type of heat transfer gas and/or liquid as the disclosure is not so limited. While any heat transfer fluid may be used, in some embodiments, the heat exchanger may be fluidly coupled to a cooling liquid source that is configured to flow a liquid through the heat exchanger. The cooling liquid source may be environmental water, water in an evaporation tank, house water, a water main, liquid in a closed cooling loop between the heat exchanger in the reactor and an external heat exchanger, and/or any source of liquid with a temperature sufficiently below the desired operational temperature of a reactor to permit effective cooling. For example, depending on the embodiment, appropriate temperatures of the cooling liquid source may be between or equal to 0° C. and 40° C. Of course, in some embodiments a cooling liquid source may have a temperature less than 0° C. or greater than 40° C. as the disclosure is not so limited. For example, a heat transfer liquid including an antifreeze or simply comprising a liquid that freezes below 0° C. could be used. Thus, it should be understood that any appropriate temperature of cooling fluid may be used that is less than a desired operating temperature of a reactor and offers sufficient cooling capacity to maintain the reactor in the desired operational range as the disclosure is not so limited.

In any of the embodiments disclosed herein, the pressure within the internal volume of the reactor chamber may be greater than a pressure of the cooling liquid in the heat exchanger. The pressure within the reactor, and that of the hydrogen, may be greater than or equal to 5 MPa, 10 MPa, 15 MPa, 20 MPa, 25 MPa, 30 MPa, or other appropriate range. The pressure within the reactor and that of the hydrogen may be less than or equal to 70 MPa, 35 MPa, 30 MPa, 25 MPa, 20 MPa, 15 MPa, 10 MPa, or other appropriate range. Combinations of the above are contemplated. For example, in some embodiments the pressure in the reactor and of the hydrogen may be between or equal to 5 MPa and 35 MPa. In other embodiments, the pressure in the reactor and of the hydrogen may be between 20 MPa and 35 MPa. In yet other embodiments a pressure within the internal volume may be between or equal to 20 MPa and 70 MPa. Of course, pressures greater than those noted above are also possible.

As noted previously, in some embodiments, it may be desirable to control the temperature within a reactor such that the water within the reactor does not boil and/or to reduce an amount of steam generated and/or to stay below a threshold temperature to avoid degradation of the fuel and/or damage to components of the reactor. Without wishing to be bound by theory, it is appreciated that the boiling point of water is dependent on pressure. Thus, different operational pressures for different systems may potentially be associated with different threshold temperatures. In some embodiments, the temperatures within the reactor during hydrogen generation (i.e., the threshold temperature) may be greater than or equal to 40° C., 50° C., 60° C., 70° C., 80° C., 90° C., or other appropriate range. In some embodiments, the temperatures within the reactor may be less than or equal to 100° C., 90° C., 80° C., 70° C., 60° C., 50° C., or other appropriate range. Combinations of the above are contemplated. For example, in some embodiments the temperature within the reactor may be maintained between or equal to 40° C. and 90° C. In other embodiments, the temperature may be maintained between or equal to 40° C. and 100° C. Depending on the embodiment, avoiding boiling may improve an efficiency of the reaction.

As mentioned previously, it is contemplated that depending on the embodiment, the heat exchanger may be any appropriate type of heat exchanger. For example, the heat exchanger may comprise a cooling coil, a shell and tube heat exchanger, or other appropriate heat exchanger as the disclosure is not so limited. Depending on the embodiment, it may be desirable to operate the heat exchanger at relatively lower pressures to reduce a complexity of the heat exchanger and associated equipment. The lower operating pressure of the heat exchanger may also allow for a wider range of options for heat exchangers that may be used with the disclosed reactors. In some embodiments, the heat exchanger may have an internal operating pressure greater than or equal to 0.01 MPa, 0.05 MPa, 0.10, MPa, 0.15 MPa, 0.20 MPa, 0.25 MPa, 0.30 MPa, 0.35 MPa, 0.40 MPa, 0.45 MPa, 0.50 MPa, 0.55 MPa, or other appropriate range. The internal operating pressure may be less than or equal to 0.60 MPa, 0.55 MPa, 0.50 MPa, 0.45 MPa, 0.40 MPa, 0.35 MPa, 0.30 MPa, 0.25 MPa, 0.20 MPa, 0.15 MPa, 0.10 MPa, 0.05 MPa, or other appropriate range. Combinations of the above are contemplated. In some embodiments, the internal operating pressure may be between or equal to 0.1 MPa and 0.5 MPa. In other embodiments, the internal operating pressure may be between or equal to 0.01 MPa and 0.60 MPa.

In some embodiments, an outer diameter, or other maximum transverse cross sectional dimension, of tubing of the heat exchanger may be greater than or equal to 0.50 cm, 0.75 cm, 1.00 cm, 1.25 cm, 1.50 cm, 1.75 cm, 2.00 cm, 2.25 cm, 2.5 cm, 2.75 cm, or other appropriate range. In other embodiments, the outer diameter, or other maximum transverse cross sectional dimension, may be less than or equal to 3.00 cm, 2.75, 2.50 cm, 2.25 cm, 2.00 cm, 1.75, 1.50 cm, 1.25 cm, 1.00 cm, 0.75 cm, or other appropriate range. Combinations of the above are contemplated. In some embodiments, the outer diameter, or other maximum transverse cross sectional dimension, may be between or equal to 1.00 cm and 2.00 cm. In other embodiments, the outer diameter, or other maximum transverse cross sectional dimension, may be between or equal to 0.50 cm and 3.00 cm. Without wishing to be bound by theory, varying the outer diameter, or other maximum transverse cross sectional dimension, of the coils may alter an amount of heat removed from the internal volume during operation.

Due to a relatively higher pressure within the internal volume and a relatively lower pressure within the heat exchanger, the heat exchanger may be configured to support a pressure differential between the internal volume and the heat exchanger without failing. In some embodiments, a wall thickness of the heat exchanger, which may be a coil in some embodiments, may be greater than or equal to 2.00 mm, 2.50 mm, 3.00 mm, 3.50 mm, 4.00 mm, 4.50 mm, or other appropriate range. In other embodiments, the wall thickness may be less than or equal to 5.00 mm, 4.50 mm, 4.00 mm, 3.50 mm, 3.00 mm, 2.50 mm, or other appropriate range. Combinations of the foregoing are contemplated, for example a wall thickness may be between or equal to 2.00 mm and 5.00 mm. Without wishing to be bound by theory, a risk of failure due to the pressure differential may be minimized by sizing the heat exchanger appropriately. For example, a wall thickness, shape, and/or outer maximum transverse cross-sectional dimension (e.g., an outer diameter) of the heat exchanger may be selected not only to remove a desired amount of heat, but also to withstand the pressure differential during hydrogen generation.

During operation, the internal volume of the reactor may be filled with a sufficient amount of water to facilitate self-pressurization of the reactor due to hydrogen generation due to liquid water being substantially incompressible. In some embodiments a volume ratio of liquid water to the internal volume of the reactor during hydrogen generation may be greater than or equal to 0.60, 0.70, 0.80, or other appropriate range. In other embodiments, the volume ratio of water to the internal volume may be less than or equal to 0.95, 0.90, 0.80, 0.70, or other appropriate range. Combinations of the above are also contemplated, for example a volume ratio between or equal to 0.60 and 0.95. In other embodiments, the volume ratio may be between 0.80 and 0.95. It is contemplated that varying the volume ratio may affect the pressure of hydrogen produced by limiting the head space within which the hydrogen may accumulate. For example, depending on the amount of hydrogen produced, a higher volume ratio of water to the internal volume may decrease the head space, leading to an increased pressure in the internal volume for the same amount of hydrogen gas.

In certain embodiments, and as explained in greater detail herein, the water-reactive material may comprise aluminum or an alloy thereof. Without wishing to be bound by theory, water and aluminum react to produce hydrogen gas according to either of the following exothermic reactions shown in reactions (1) and (2):

$$2 Al + 4 {H}_{2} O \to 3 {H}_{2} + 2 A lO ( OH ) + Q 1 \qquad ( 1 )$$

$$2 Al + 6 {H}_{2} O \to 3 {H}_{2} + 2 {Al ( OH )}_{3} + Q 2 \qquad ( 2 )$$

where Q1 and/or Q2 are heat.

Depending on the embodiment, the water-reactive material may comprise any appropriate shape and/or form. For example, the material may comprise pellets, balls, powders, particles, chunks of material, and/or slurries. The water-reactive material may be regularly shaped, such as spherical, or may be irregularly shaped chunks. The size of the water-reactive material may be uniform or varied. Alternatively, the water-reactive particles may be provided in a more continuous form, such as a powder with any appropriate size distribution for a desired application. Depending on the embodiment, the size distribution may be substantially uniform, such that the size of particles within the powder are substantially homogeneous.

In some embodiments, the water-reactive material may have an average maximum transverse dimension that is greater than or equal to 100 μm, 250 μm, 500 μm, 1 mm, 5 mm, 1 cm, 5 cm, or other appropriate ranges. The average maximum transverse dimension may be less than or equal to 10 cm, 8 cm, 5 cm, 2 cm, 1 cm, 5 mm, 1 mm, 500 μm, 250 μm, or other appropriate ranges. Combinations of the above are contemplated. For example, in some embodiments, the water-reactive material may have an average maximum transverse dimension between or equal to 100 μm and 10 cm. Controlling the average size of the water-reactive material may be advantageous to dispense the material into a reaction chamber at a desired rate. Additionally or alternatively, controlling the size of the water-reactive material may be advantageous to minimize clogging and/or jamming while dispensing the material into the reaction chamber.

As mentioned above, hydrogen gas is produced by exposing water-reactive material to water. In some such embodiments, the rate and amount of hydrogen gas produced can be controlled by modifying the type and concentration of certain water-reactive materials. In some embodiments, the water-reactive material comprises aluminum, as described above in relation to reactions (1) and (2). However, other metals may also be used depending on the particular embodiment. Non-limiting examples of water-reactive materials that may be used are aluminum, lithium, sodium, magnesium, zinc, boron, beryllium, alloys thereof, and/or mixtures thereof.

The water-reactive materials, in some embodiments, comprise an activating composition that is permeated into the grain boundaries and/or subgrain boundaries of the reactant (e.g. aluminum) to facilitate its reaction with water. For example, a reactant may include aluminum combined with gallium and/or indium. In some instances, the activating composition may be a eutectic, or close to eutectic composition, including for example a eutectic composition of gallium and indium. In one such embodiment, the activating composition may comprise gallium and indium where the portion of the activating composition may have a composition of about 70 wt. % to 80 wt. % gallium and 20 wt. % to 30 wt. % indium, though other weight percentages are also possible. Without wishing to be bound by theory, gallium and/or indium may permeate through one or more grain boundaries and/or subgrain boundaries of the reactant (e.g., aluminum).

In certain embodiments, the activating composition may be incorporated into an alloy with the reactant. A metal alloy may comprise any activating composition in any of a variety of suitable amounts. In some embodiments, for example, the metal alloy comprises greater than or equal to 0.1 wt. % of the activating composition, greater than or equal to 1 wt. %, greater than or equal to 5 wt. %, greater than or equal to 15 wt. %, greater than or equal to 30 wt. %, or greater than or equal to 45 wt. % of the activating composition based on the total weight of the metal alloy. In certain embodiments, the metal alloy comprises less than or equal to 50 wt. %, less than or equal to 40 wt. %, less than or equal to 30 wt. %, less than or equal to 20 wt. %, less than or equal to 10 wt. %, less than or equal to 5 wt. %, or less than or equal to 1 wt. % of the activating composition, based on the total weight of the metal alloy. Combinations of the above recited ranges are also possible (e.g., the metal alloy comprises greater than or equal to 0.1 wt. % and less than or equal to 50 wt. % of the activating composition based on the total weight of the metal alloy, the metal alloy comprises greater than or equal to 1 wt. % and less than or equal to 10 wt. % of the activating composition based on the total weight of metal alloy). In some embodiments, the metal alloy the activating composition is incorporated into may be an aluminum alloy, though other water-reactive materials may also be used. Other ranges are also possible.

In some instances where a slurry is used, the water-reactive material within a slurry may be suspended in any appropriate carrier fluid. This carrier fluid may be a shear thinning fluid, though the disclosure is not limited to only using shear thinning fluids. As used herein, the phrase “shear thinning fluid” is given its ordinary meaning in the art and generally refers to a fluid whose viscosity decreases under shear strain. Any of a variety of suitable shear thinning fluids may be utilized. In some embodiments, for example, the carrier fluid may comprise oil, such as mineral oil, canola oil, and/or olive oil. In certain embodiments, the carrier fluid may comprise a grease, alcohol, or other appropriate material capable of suspending the water-reactive particles in the carrier fluid. In certain embodiments, the carrier fluid comprises fumed silica thickening agents, or other appropriate thickening agents.

The Inventors have also realized that hydrogen produced within the reaction chamber can be used for any number of different uses. The produced hydrogen may also be stored under high pressure in tanks, canisters, and/or other appropriate pressurized gas containers. The produced hydrogen may also be used for filling lighter than air systems such as balloons (e.g., high altitude balloons, tethered balloons), blimps, and other appropriate systems. The produced hydrogen gas may also be used to produce electricity and/or mechanical work (e.g., via a fuel cell, turbine, and/or internal combustion engine). Thus, the disclosed systems and corresponding produced hydrogen may be used for any number of different applications. In some specific embodiments, hydrogen gas can be used to fill removeable, high-pressure hydrogen canisters that can be integrated into systems such as fuel cells, unmanned aerial vehicles, ground vehicles, ground sensors, cookstoves, or any other appropriate system. The Inventors have realized that pressurized hydrogen can be fed directly into systems to provide electrical power. For example, hydrogen may be used for continuous power generation for remote sensors, remote command posts, remote charging, or other remote and/or unattended applications. In instances where a desired end use operates at a lower pressure than the pressures generated in the reactors and methods disclosed herein, appropriate valves, restrictions, and/or gas throttles may be used to reduce the gas pressure to an appropriate operating range of an associated system.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

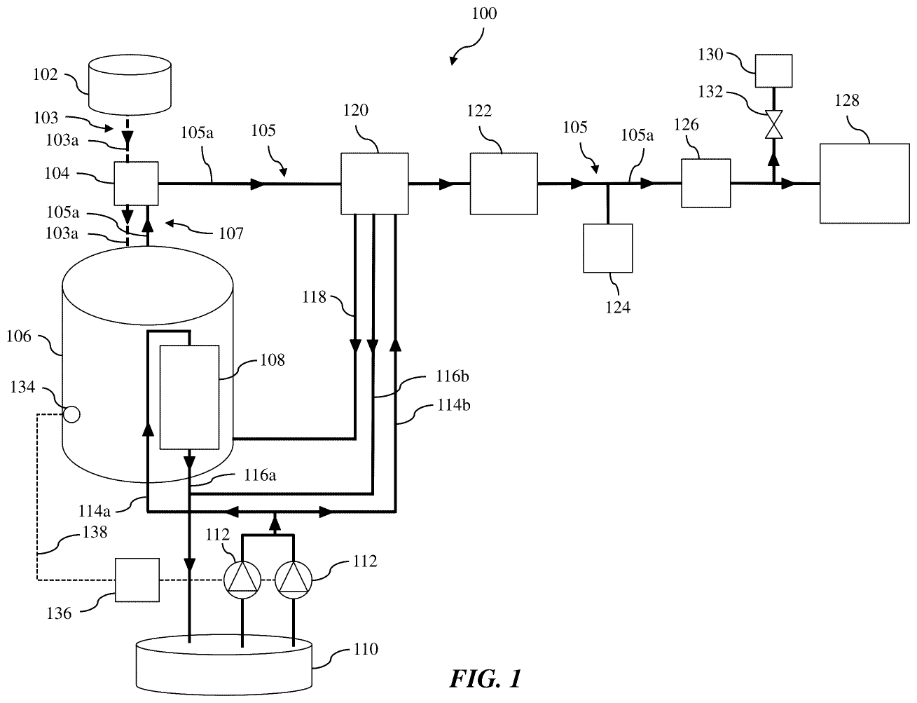

FIG. 1 displays one embodiment of a reactor 100 configured to produce high-pressure hydrogen. As a general overview of the system, in some embodiments, a reactant such as a water-reactive material may combine with water to produce pressurized hydrogen within an internal volume of a reactor chamber 106. The generated hydrogen has a volume under ambient pressure that is much greater than a volume of the headspace present in the reactor chamber 106. Therefore, generation of the hydrogen in this enclosed internal volume of the rigid reactor chamber 106 causes the hydrogen to be self-pressurized to the relatively high pressures disclosed herein. The pressurized hydrogen may flow out from an outlet of the reactor chamber 106 through a hydrogen flow path 105a that is fluidly coupled to the outlet of the reactor chamber. As elaborated on further below, this flow of pressurized hydrogen may be conditioned and its pressure regulated to obtain hydrogen with desirable characteristics for an end use (pressure, moisture content, etc.)

While in some embodiments a predetermined amount of reactant may be combined with the water within the internal volume of a reactor chamber 106, in other embodiments, it may be desirable to control an amount of reactant in the reactor chamber 106 to control a rate of hydrogen production and/or pressure within the reactor chamber 106. Thus, as depicted in FIG. 1, in some embodiments, a reactor 100 may include a metering hopper 102 configured to selectively feed a desired amount of the reactant into the internal volume of the reactor chamber 106. The metering hopper 102 may be coupled to the internal volume of the reactor chamber 106 by a material chute 103 configured to direct material dispensed from the metering hopper 102 into the reactor chamber 106. As shown in FIG. 1, in some embodiments the metering hopper 102 is a gravity feeder, though embodiments in which other types of metering hoppers are used are also contemplated.

In some embodiments, the metering hopper 102 may comprise a reactant reservoir configured to contain the reactant. The metering hopper may further comprise a reactant feeder configured to selectively feed the reactant from the reactant reservoir to the reactor chamber 106. Metering hopper 102 may also include a motor or other appropriate actuator configured to actuate the reactant feeder. During operation, the reactant may be disposed in the reactant reservoir and the reactant feeder may selectively dispense a predetermined amount of reactant from the metering hopper 102 into the reactor chamber 106. It is contemplated that, in some embodiments, selectively feeding a measured amount of the water-reactive material into the reactor chamber 106 may at least partially control a reaction rate and/or an amount of hydrogen produced within the reactor chamber 106. For example, the metering hopper 102 may be configured to dispense a desired amount of the reactant into the reactor at set time intervals and/or based on a sensed pressure from within an internal volume of the reactor chamber 106 to control the reaction. In this way, the amount of hydrogen produced may be controlled by dispensing desired amounts of reactant into the reactant chamber 106.

Again, while a metering hopper is discussed above, it is also contemplated that in some embodiments, a single dose of reactant can be added at once to the reactor chamber 106. In such a configuration, the single dose may be added, and the reactor chamber 106 may be sealed during the reaction as the disclosure is not limited in this fashion.

Returning to the embodiment presented in FIG. 1, the reactor chamber 106 may be operatively connected to the metering hopper 102 and downstream systems in any appropriate manner. For example, in the depicted embodiment, a multiple flow path connector 104, which in the depicted embodiment is a three-way junction, may fluidly couple the internal volume of the reactor chamber 106 with the metering hopper 102 and a hydrogen conduit 105. For example, during operation the multiple flow path connector 104 may couple a material chute 103 of the metering hopper 102 to the internal volume of the reactor chamber 106, allowing the reactant to flow from the metering hopper 102 to reactor chamber 106 through the multiple flow path connector 104. The multiple flow path connector 104 may also fluidly couple the internal volume of the reactor chamber 106 to the hydrogen conduit 105, allowing hydrogen gas to flow from the reactor chamber 106 along a hydrogen flow path 105a through hydrogen conduit 105. In this manner, the multiple flow path connector may form at least a portion of the material flow path 103a and/or at least a portion of the hydrogen flow path 105a. In some embodiments, the hydrogen flow path 105a and a material flow path 103a may be at least partially coextensive within the multiple flow path connector 104 and a port of the reactor chamber 106. However, embodiments in which these flow paths are separate from each other and/or separate connectors are used are also contemplated.

At a first junction, the multiple flow path connector 104 may be operatively connected to metering hopper 102 such that the multiple flow path connector 104 at least partially defines a material chute 103. The material chute 103 may at least partially define a material flow path 103a through which the reactant passes from metering hopper 102. At a second junction, the multiple flow path connector 104 may also be connected to the reactor chamber 106. In some embodiments, the depicted material flow paths 103a and hydrogen flow path 105a may be at least partially formed by a combined channel 107. Within combined channel 107, the reactant may pass through the material chute, along material flow path 103a, and into reactor chamber 106. Hydrogen gas from the reactor chamber may also flow out from the reactor chamber 106 through the combined channel 107. In this regard, combined channel 107 may at least partially define a portion of material flow path 103a and at least a portion of hydrogen flow path 105a. This arrangement may allow the reactant and/or gas to flow through the multiple flow path connector 104 simultaneously or independently during operation. At a third junction, multiple flow path connector 104 is fluidly connected to the hydrogen conduit 105, thus fluidly coupling the reactor chamber 106 and the hydrogen conduit 105 to allow hydrogen to flow from the reactor chamber 106 through the hydrogen conduit 105 to an outlet or other associated system.

As noted above, it is contemplated that the hydrogen and the reactant may pass through a single channel forming the combined channel 107 in the multiple flow path connector 104. However, in other embodiments, two independent channels for the reactant and the hydrogen formed in a single connector or multiple connectors may be used as the disclosure is not so limited.

As mentioned, producing hydrogen gas within the reactor chamber may lead to elevated temperatures and/or pressures. As such, in some embodiments, a heat exchanger 108 configured to remove heat from the reactor chamber 106 may be disposed within the reactor chamber 106 (e.g., within an internal volume of the reactor chamber 106). As discussed further below, the heat exchanger 108 may absorb heat from within the reactor chamber and remove the heat to an external environment through the flow of a cooling fluid through the heat exchanger 108. In some embodiments, at least one sensor 134 may be disposed within the reactor chamber. For example, the at least one sensor 134 may be configured to sense a temperature and/or pressure within the reactor chamber 106. Signals output from the at least one sensor 134 may allow active monitoring and control of the temperature and/or pressure within the reactor chamber 106 as elaborated on further below.

The depicted hydrogen flow path 105a including the hydrogen conduit 105 may be formed using any appropriate types of flow paths capable of supporting the pressures of the generated hydrogen disclosed herein. For example, depending on the embodiment, the hydrogen conduit may comprise pipes, hoses, conduits formed in solid components and/or any other type of flow path capable of transporting the flow of pressurized hydrogen. Depending on the embodiment, the flow paths may be formed from any suitable rigid material and/or construction configured to withstand the elevated pressures and temperatures of the generated hydrogen gas. This may include, but is not limited to rigid plastics, stainless steel, copper, rubber, reinforced tubing, or any other appropriate material as the disclosure is not so limited. In some embodiments, the conduit may be configured to withstand elevated pressures and/or temperatures of the hydrogen gas.

As mentioned previously, heat exchanger 108 is disposed within reactor chamber 106 and is configured to flow the cooling liquid from a cooling liquid source through the heat exchanger. Heat exchanger 108 may be fluidly coupled to the cooling liquid source 110, where the cooling liquid source 110 may either be a source of pressurized or unpressurized cooling liquid that is configured to provide a flow of cooling fluid to the heat exchanger 108. In some embodiments, the heat exchanger may comprise a plurality of coils disposed in the reactor chamber. However, it is appreciated that the heat exchanger may comprise any appropriate heat exchanger configuration capable of exchanging heat with the internal volume of the reactor chamber 106 as the disclosure is not so limited. In some embodiments, the cooling liquid source 110 may comprise a cooling liquid reservoir configured to contain the cooling liquid. In some embodiments, the cooling liquid may be water.

In embodiments in which the cooling liquid source 110 is not pressurized to a sufficient pressure to flow through the heat exchanger 108, at least one pressure source 112 may be configured to flow, and in some embodiments circulate, the cooling liquid from the cooling liquid source 110 through the heat exchanger 108. In the embodiment of FIG. 1, the at least one pressure source 112 comprises one or more pumps in fluid communication with cooling liquid source 110 which is depicted as an evaporation tank though other appropriate reservoirs with the cooling liquid disposed therein may also be used. In some embodiments, having more than one pump may be desirable for redundancy and/or increased flow rates. However, it is appreciated that some embodiments may include only one pump. It is also appreciated that any source of pressurized cooling liquid may be used to circulate the cooling liquid. For example, the heat exchanger 108 may be fluidly coupled to a domestic water supply (e.g., a pressurized water supply provided by pipes at a pressure around 0.4 MPa), a water main, or any other appropriate pressurized source of cooling liquid as the disclosure is not so limited.

In the depicted embodiment, the at least one pressure source 112 is fluidly coupled to the cooling liquid source 110 and a cooling liquid supply flow path 114a which is fluidly coupled to the heat exchanger 108 to provide cooling liquid to the heat exchanger 108 disposed in the reactor chamber 106. Without wishing to be bound by theory, as cooling liquid circulates through heat exchanger 108, energy in the form of heat is removed from reactor chamber 106 and absorbed into the cooling liquid. Removing energy from the reactor chamber may help maintain the temperature within the reactor chamber 106 below a desired threshold temperature. Cooling liquid that has absorbed heat from the reactor chamber 106 may flow out from the heat exchanger 108 through cooling liquid return flow path 116a fluidly coupled to an outlet of the heat exchanger 108. In some embodiments, the cooling liquid return flow path 116a may be fluidly coupled to the cooling liquid source 110 to permit return of the cooling liquid to the cooling liquid source 110 where heat may be dissipated to the external environment.

In some embodiments, the at least one sensor 134 may be coupled via a wireless or wired electronic connection 138 to one or more controllers 136 which may comprise one or more processors and corresponding non-transitory computer readable memory. The non-transitory computer readable memory may include processor executable instructions that when executed by the one or more processors cause the reactor to perform any of the methods disclosed herein. For example, the one or more controllers 136 may be configured to actuate the at least one pressure source 112 to control the flow of cooling liquid to the heat exchanger 108. During operation, the at least one sensor 134 may output a signal to the one or more controllers 136. Depending on the desired setpoints of the reactor 100, the one or more controllers may actuate the at least one pressure source 112 to control the rate of flow of cooling liquid through reactor chamber to maintain a temperature of the reactor to be within a desired operational temperature range and/or below a threshold temperature as noted previously above. Alternatively or additionally, the one or more controllers 136 may receive a pressure signal from the at least one sensor 134 and may be configured to control other aspects of the reactor 100 such as feed rates from the metering hopper 102, valve open or closed states, or other appropriate operating parameters as the disclosure is not so limited.

Hydrogen gas produced within the reactor chamber 106 may contain moisture. For example, heat within the reactor chamber may cause the liquid water within the reactor chamber to produce gaseous water. This gaseous water may mix with the hydrogen gas, causing the reactor to output “wet” hydrogen. Moisture contained within the hydrogen may cause issues within associated systems that utilize the hydrogen for fuel such as equipment fouling, less efficient combustion, or other undesirable effects. Thus, a conditioning manifold 120 may be fluidly coupled to the hydrogen conduit 105. The conditioning manifold may be configured to remove moisture from the flow of hydrogen gas. For example, the conditioning manifold may comprise a condensation coil fluidly coupled to the hydrogen conduit 105 fluidly coupled to the reactor chamber 106. In some embodiments, the condensation coil may be operatively coupled with a heat exchanger to cause the water vapor to condense within the condensation coil. Appropriate constructions may include, but are not limited to, a tube in tube, a shell in tube, an immersed coil, or other appropriate construction as the disclosure is not so limited.

The conditioning manifold may be appropriately configured and oriented such that condensed water is removed from the flow of hydrogen gas may flow back into the reactor chamber through condensate flow path 118 fluidly coupled to the conditioning manifold 120 and the reactor chamber 106. This may help reduce a frequency at which water is replenished within the reactor chamber while also drying the flow of hydrogen. It is contemplated that the condensate flow path 118 may comprise any suitable type of flow path capable of withstanding the applied pressures and temperatures within the reactor 100 as noted above. In either case, in the depicted embodiment, the condensate may be gravity fed into the reactor chamber 106. In other embodiments, a condensate pump and/or one-way valve may be disposed along condensate flow path 118 to transport the condensate into the reactor chamber 106. Upon exiting the conditioning manifold 120, the hydrogen gas may be considered “dry” as excess moisture has been removed from the flow of hydrogen.

In some embodiments, the cooling liquid source 110 and one or more pressure sources 112 may be used to provide a cooling liquid to the hydrogen conditioning manifold 120 as well. For example, the cooling liquid flow path may branch such that at least one pressure source 112 supplies the cooling liquid through cooling liquid supply 114b that is fluidly coupled to the hydrogen conditioning manifold 120 to provide appropriate cooling to cause the gaseous water in the flow of hydrogen to condense into the liquid phase. The cooling liquid, now carrying energy in the form of heat, may then flow through a cooling liquid return 116b fluidly coupled to an outlet of the hydrogen conditioning manifold 120 to return the cooling liquid to the cooling liquid source 110, though embodiments in which the cooling liquid is not recirculated are also contemplated. As shown in FIG. 1, in some embodiments cooling liquid returns 116a and 116b may connect prior to flowing the cooling liquid back into the cooling liquid source 110. While not shown, it is contemplated that a sensor arrangement similar to the arrangement described above can be included in the conditioning manifold. At least one sensor can be disposed within the conditioning manifold to measure properties of the hydrogen gas (e.g., temperature, pressure, humidity, etc.) and relay the measurements to the one or more controllers 136 to regulate the flow of cooling liquid to the hydrogen conditioning manifold 120.

It the above embodiments, the cooling liquid circulating through the reactor chamber and conditioning manifold may be water although any appropriate cooling fluid may be used as the disclosure is not so limited. For example, a refrigeration cycle could be used to provide the desired cooling with an appropriate arrangement of pumps, heat exchangers, and a refrigerant circulation loop. Additionally, while in FIG. 1 the conditioning manifold 120 and reactor chamber 106 share the cooling liquid source 110 and pressure sources 112, it is contemplated that depending on the embodiment, the conditioning manifold 120 and reactor chamber 106 could have separate cooling systems. It is appreciated by the Inventors that in some embodiments a pressure of the cooling liquid in heat exchanger 108 may be less than a pressure of the produced hydrogen gas in the reactor chamber. This may allow for a wider range of options for cooling systems and/or for reduced complexity of the system.

In some embodiments, a filter 122 may also be disposed along the hydrogen flow path. For example, the filter 122 may be fluidly coupled to the hydrogen conditioning manifold 120 or other portion of the hydrogen flow path. The filter 122 may be configured to purify the flow of hydrogen gas. In some embodiments, the filter may comprise a filter material configured to remove volatile gases, contaminants, vapors, and/or other impurities from the hydrogen gas. Appropriate types of filters and/or purifiers may include, but are not limited to mechanical, chemical, catalytic, or other appropriate type of filter and/or purifier. In some embodiments, a mechanical filter and/or purifier may include frit(s), foam(s), packed bed(s), fiber(s), or other construction and/or material. In some embodiments, a chemical and/or catalytic filter may remove or convert a gas vapor in the flow of hydrogen. Examples of a chemical filter and/or purifier may include a desiccant (Drierite), an adsorbent (Pur-Gas), or other appropriate chemical filter and/or purifier. Examples of a catalytic filter and/or purifier may include a sorbent (SulfaTrap) or other appropriate catalytic filter and/or purifier. Additionally or alternatively, the filter 122 may include a sulfur trap. Flowing hydrogen through the filter 122 may remove particles from the flow of hydrogen gas such that substantially pure hydrogen may flow out of the filter 122 for use with associated systems. Contaminants that may be removed may include, but are not limited to t-Butyl Mercaptan (C4H10S); Dimethyl Disulfide (C2H6S2); 2-Ethylthiophene (C6H8S); and Carbonyl Sulfide (COS).

While a majority of the gaseous water may be removed by the hydrogen conditioning manifold 120, some gaseous water may still be contained within the flow of hydrogen. Some of this gaseous water may condense along the flow path downstream from the hydrogen conditioning manifold 120. Thus, in some embodiments, a water trap 124 may also be disposed along the hydrogen flow path 105a downstream from the filter 122 and may be configured to remove and/or capture any excess gaseous and/or condensed water that may be present within the hydrogen conduit 105 at this point. Appropriate types of water traps may include, but are not limited to liquid separators, desiccants, gravity water traps, or other appropriate methods of capturing excess water. The water trap 124 may be configured to remove and/or store the excess water. In some embodiments, the water trap may be fluidly coupled to the reactor chamber 106. For example, in some embodiments, similar to the conditioning manifold 120, liquid water may be routed from the water trap 124 back into the reactor chamber.

During operation, hydrogen produced in the reactor chamber may have a pressure greater than a desired pressure. Accordingly, in some embodiments, a pressure regulator 126 may be disposed along the hydrogen flow path 105a. The pressure regulator 126 may be configured to reduce the pressure of the hydrogen gas to a desired pressure and/or to be within a desired pressure range. It is contemplated that any appropriate device and/or configuration may be used to regulate the pressure of the hydrogen gas. For example, a pressure regulating valve, static flow restriction, a variable flow restriction, and/or any other type of pressure regulator may be used. In some embodiments, the reactor 100 may also include a pressure relief valve, not depicted, that may be disposed along the hydrogen flow path 105a that opens to the atmosphere when the pressure of the hydrogen gas is above a set threshold pressure. Additionally, in some embodiments, after the hydrogen passes through pressure regulator 126, the hydrogen may pass through a check valve (not shown) to reduce a risk of backflow through the system in the upstream direction towards the reactor chamber 106. The hydrogen may then be directed to one or more high-pressure systems 128 and/or low-pressure systems 130 fluidly coupled to the hydrogen conduit 105, which in the depicted embodiment is an outlet of the pressure regulator 126.

In some embodiments, the high-pressure system may comprise a storage vessel configured to store hydrogen for later use, transportation, and/or use in remote environments. Alternatively, any system using high-pressure hydrogen as fuel may be connected to the reactor 100 at the high-pressure outlet as the disclosure is not so limited. It is appreciated that high-pressure systems may have a maximum operating pressure. Therefore, maintaining the pressure of hydrogen at or below the maximum operating pressure may improve performance, limit wear, and/or reduce damage to the associated high-pressure system. An isolation valve (not shown) may be disposed along the hydrogen flow path 105a at the high-pressure outlet to provide control of the flow of hydrogen out of the high-pressure outlet. The high-pressure outlet may also be configured as a quick-connect to quickly couple and decouple an associated high-pressure system.

While the hydrogen produced within the reactor chamber may be high-pressure, the Inventors have appreciated that reactor 100 may produce both high- and low-pressure hydrogen. Since the system is producing high-pressure hydrogen, if low-pressure hydrogen is desired, then at least a portion of the high-pressure hydrogen could be regulated down to a lower pressure for use with a low-pressure system 130. In some embodiments the low-pressure system may be connected to a low-pressure outlet of reactor 100. The low-pressure system may be any appropriate system as the disclosure is not so limited. A flow restriction 132 may be disposed along hydrogen flow path 105a prior to the low-pressure outlet. In some embodiments, the flow restriction may comprise a pressure reducing valve, a fixed flow restriction, a variable flow restriction, or any other arrangement, device, or configuration capable of reducing the pressure of the hydrogen gas to be within a desired lower pressure range as the disclosure is not so limited. Low-pressure hydrogen may then flow out of the flow restriction to power equipment directly. For example, continuous low-pressure hydrogen could directly supply a fuel cell with hydrogen fuel. Low-pressure hydrogen can also power remote sensors, charging stations, or any other low-pressure system as the disclosure is not so limited. As with the high-pressure outlet, the low-pressure outlet may comprise an isolation valve to control the flow of hydrogen gas. In some embodiments, the low-pressure outlet may comprise a quick-connect to facilitate a convenient connection between the reactor and the low-pressure system.

Although not shown, reactor 100 may further comprise valving at desired locations to selectively isolate parts of the system (e.g. isolation valve), control flow (e.g., one-way valve, check valve), and/or control pressure (e.g. pressure regulators, pressure reducing valves, pressure relief valves, burst disks, etc.). The reactor may also include various sensors throughout the system to measure and/or monitor conditions within the system. The sensors may be connected to a controller to manipulate any appropriate equipment (e.g., valves, pumps, dispensers, outlets, etc.) to control any desired conditions (e.g., flows, reaction rates, temperatures, pressures, humidity, etc.). Additionally, it is contemplated that the various portions of the reactor may be connected to each other using any appropriate fittings and couplings capable of appropriately connecting and sealing the various portions of the reactor 100 to each other. For example, gas quick-connect fittings, compression fittings, flange and seal arrangements, and/or any other appropriate type of fluid and gas tight connection capable of supporting the pressure and temperatures disclosed herein may be used as the disclosure is not so limited.

In addition to the above, in some embodiments it is also contemplated that a vacuum pump (not shown) may be in fluid communication with the hydrogen flow path 105a to permit evacuation of the hydrogen flow path 105a (e.g., conduits, filters, conditioning modules, etc.) prior to hydrogen generation. This may help eliminate other gases, contaminants, moisture, etc. within the hydrogen flow path 105a which may improve the quality of hydrogen produced by the reactor. This may also help with avoiding mixing of oxygen with the headspace in undesirable concentration ranges.

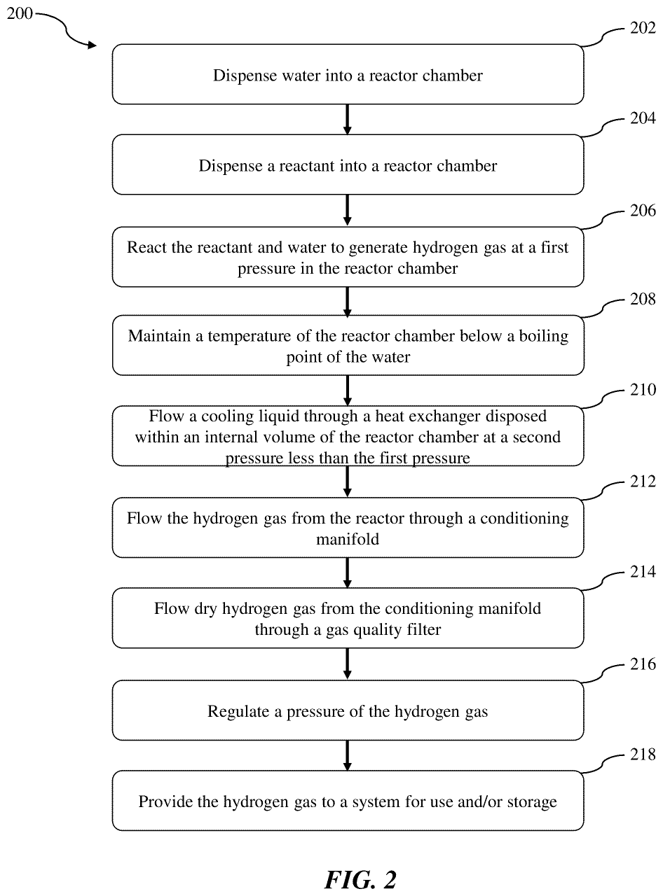

Turning to FIG. 2, a method 200 for generating hydrogen gas according to an embodiment may comprise dispensing water into a reactor chamber at 202. The water may be added and then the reactor chamber may be sealed. The water may be any desired amount of water, and it is contemplated that increasing a volume of water (e.g., the volume ratio described previously) within the reactor chamber may increase a pressure of hydrogen produced, due to a relatively smaller volume of head space within the reactor chamber where hydrogen may accumulate using any of the volume ratios noted previously above. At 204, a reactant (e.g., a water-reactive material) may be dispensed into the reactor chamber. For example, a metering hopper may be configured to selectively provide reactant into the reactor chamber using the previously described constructions. In some embodiments, the reactant feeder meters an amount of reactant being added to the reactor to either continuously or periodically dispense the reactant into the reactor chamber. It is also contemplated that in some embodiments, a desired amount of reactant may be added at one time to the reactor prior to sealing the reactor chamber.

At 206, the water and the reactant are combined in the reactor chamber. The resulting reaction may produce hydrogen gas. This reaction may both pressurize and heat the materials in the reactor chamber. As described previously, the heat of the reaction may cause localized boiling of the water in close proximity to the reaction site. Elevated temperatures, depending on the pressure, may also lead to steam generation and/or degradation of the fuel. Therefore, at 208, it may be desirable to maintain a temperature within the reactor to reduce an amount of steam generated. For example, the temperature may be maintained below a threshold temperature. In some embodiments, this may include utilizing one or more sensors disposed within the reactor chamber for monitoring a temperature, pressure, and/or other appropriate operating parameter of the reactor. Using the one or more sensed operating parameters, a cooling liquid source, and where appropriate a separate pressure source, may be controlled (e.g., turn on, turn off, increase flow, decrease flow, etc.) to maintain the temperature within the reactor chamber below a threshold temperature and/or within a desired range. In some embodiments, this may include circulating water continuously through the heat exchanger and measuring entering and leaving water temperatures to determine an amount of heat being removed from the reactor chamber. Alternatively, a simple predetermined flow rate of cooling liquid may be used without the use of sensors as the disclosure is not so limited.

At 210, a cooling liquid may flow through a heat exchanger disposed within an internal volume of the reactor. In some embodiments, the heat exchanger comprises a plurality of coils disposed in the reactor chamber. However, it is appreciated that the heat exchanger may comprise any appropriate heat exchanger with any appropriate shape and/or size for the desired application as the disclosure is not so limited. For example, the cooling liquid may flow between the heat exchanger disposed within the reactor chamber and a cooling liquid source. The heat exchanger may be configured to maintain a desired temperature within the reactor chamber. In some embodiments, the cooling liquid may be at a second pressure that is less than a first pressure of the hydrogen gas generated within the reactor. As discussed previously, the second pressure being less than the first pressure may be beneficial for simplicity of the cooling subsystem.

After generating the hydrogen, one or more conditioning and/or regulation steps may be performed. For example, at 212, hydrogen flows from the reactor through a conditioning manifold. Within the conditioning manifold, moisture is extracted from the hydrogen such that the “wet” hydrogen leaves the conditioning manifold as “dry” hydrogen. At 214, the hydrogen gas flows from the conditioning manifold through a filter to remove impurities such as entrapped particles such that the hydrogen leaving the filter is substantially pure hydrogen. At 216, the pressure of the hydrogen may be regulated. For example, the first pressure of the hydrogen, depending on the embodiment, may be above a threshold value and/or range for a desired application. At 218, after regulating the pressure of the hydrogen, the hydrogen may be provided to one or more systems for use and/or storage by flowing the high-pressure hydrogen through a high-pressure outlet and/or low-pressure outlet of the reactor. In instances where the pressure is output to a low-pressure system, the pressure of the hydrogen could be reduced further as described previously above.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03

1. A reactor for producing hydrogen gas, the reactor comprising:
a reactor chamber configured to contain a reactant and water, wherein when the reactant is combined with the water in the reactor chamber a reaction produces hydrogen gas;
a cooling liquid source;
a heat exchanger disposed in the reactor chamber, wherein the heat exchanger and the cooling liquid source are configured to flow a cooling liquid from the cooling liquid source through the heat exchanger.

2. The reactor of claim 1, further comprising a cooling pump configured to flow the cooling liquid from the cooling liquid source through the heat exchanger.

3. The reactor of claim 1, wherein the cooling liquid source is a cooling liquid reservoir configured to contain the cooling liquid.

4. The reactor of claim 1, wherein the cooling pump and heat exchanger are configured to maintain a temperature of the reactor chamber between 50° C. and 90° C. during operation.

5. The reactor of claim 1, wherein the heat exchanger comprises a plurality of coils disposed in the reactor chamber.

6. The reactor of claim 1, wherein during operation, a pressure of the cooling liquid in the heat exchanger is less than a pressure of the produced hydrogen gas in the reactor chamber.

7. The reactor of claim 1, wherein the pressure of hydrogen gas in the reactor chamber is between or equal to 5 MPa and 35 MPa.

8. The reactor of claim 1, further comprising:
a reactant reservoir configured to contain a reactant; and
a reactant feeder configured to selectively provide the reactant from the reactant reservoir to the reactor chamber.

9. The reactor of claim 8, wherein the reactant feeder is a gravity feeder.

10. The reactor of claim 8, wherein the reactor chamber includes a reactor chamber port, and further comprising:
a gas outlet; and
a connector coupling the reactor chamber port with the reactant feeder and the gas outlet.

11. The reactor of claim 10, further comprising a condensation coil disposed along a flow path extending from the reactor chamber to the gas outlet.

12. The reactor of claim 1, wherein the reactant includes at least one selected from the group of aluminum, sodium, magnesium, zinc, boron, beryllium, and alloys thereof.

13. The reactor of claim 1, wherein the reactant is an alloy of aluminum, gallium, and indium.

14. A method of producing hydrogen gas, the method comprising:
combining a reactant and water in a reactor chamber to produce hydrogen; and
flowing a cooling liquid between a heat exchanger disposed within the reactor chamber and a cooling liquid source to maintain a temperature of the reactor chamber below a threshold temperature.

15. The method of claim 14, further comprising feeding the reactant into the reactor chamber using a reactant feeder.

16. The method of claim 15, further comprising flowing a cooling liquid between a condensation coil and the cooling liquid source, wherein the condensation coil is disposed along a flow path extending from the reactor chamber to the gas outlet.

17. The method of claim 14, wherein the temperature of the reactor chamber is maintained between or equal to 50° C. and 90° C.

18. The method of claim 15, wherein the reactant feeder is configured to selectively provide reactant from a reactant reservoir into the reactor chamber, wherein the reactant reservoir is configured to contain the reactant.

19. The method of claim 14, wherein the reactant includes at least one selected from the group of aluminum, sodium, magnesium, zinc, boron, beryllium, and alloys thereof.

20. The method of claim 14, wherein the reactant is an alloy of aluminum, gallium, and indium.
